(19) United States
(12) Patent Application Publication
(10) Pub. No.: US 2017/0016336 A1
(43) Pub. Date: Jan. 19, 2017

(54) BLADE ROOT FOR A TURBINE BLADE

(71) Applicant: Siemens Aktiengesellschaft, Munich (DE)

(72) Inventor: Armin de Lazzer, Mülheim an der Ruhr (DE)

(73) Assignee: Siemens Aktiengesellschaft, Munich (DE)

(21) Appl. No.: 15/123,770

(22) PCT Filed: Mar. 3, 2015
(86) PCT No.: PCT/EP2015/054339

§ 371 Date: Sep. 6, 2016

(30) Foreign Application Priority Data
Mar. 13, 2014 (EP) 14159497.8

(51) Int. Cl. F01D 5/30

(52) U.S. Cl. CPC F01D 5/3038; F05D 2230/50

(57) ABSTRACT

A turbine blade has a blade, a blade root, and a cover plate between the blade root and the blade. The cover plate has a parallelogram with a front surface and a rear surface and a first bearing surface and a second bearing surface. The blade has a profiled design and a leading edge and a trailing edge, the leading edge pointing towards the front surface and the trailing edge pointing towards the rear surface. The front surface has a curvature in at least some sections in order to prevent a plastic deformation during operation.

### CROSS REFERENCE TO RELATED APPLICATIONS

This application is the US National Stage of International Application No. PCT/EP2015/054339 filed Mar. 3, 2015, and claims the benefit thereof. The International Application claims the benefit of European Application No. EP14159497 filed Mar. 13, 2014. All of the applications are incorporated by reference herein in their entirety.

### FIELD OF INVENTION

The invention relates to a turbine blade having a blade airfoil and a blade root, wherein the blade root and the blade airfoil are formed along a blade axis that is oriented perpendicular to an axis of rotation, wherein the axis of rotation and the blade axis form a radius face and the blade root has a side face that is essentially perpendicular to the radius face.

The invention also relates to a method for producing a turbine blade arrangement in a slot of a turbomachine.

### BACKGROUND OF INVENTION

The umbrella term “turbomachine” encompasses water turbines, steam and gas turbines, wind turbines, centrifugal pumps and centrifugal compressors, and propellers. All of these machines share the characteristic that they serve the purpose of extracting energy from a fluid and thus driving another machine, or conversely of imparting energy to a fluid in order to raise the pressure thereof.

Steam turbines, as an embodiment of a turbomachine, essentially comprise a rotor that is mounted so as to be able to rotate, and a casing arranged around the rotor. In general, steam turbines are made up of an inner casing and an outer casing, wherein the outer casing is arranged around the inner casing. The rotor comprises turbine rotor blades that are distributed around the circumference and that are generally arranged adjacent to one another in slots. This results in multiple turbine rotor blade rows arranged one behind the other along the axis of rotation. The inner casing in turn comprises turbine guide blades that are also arranged adjacent to one another in a circumferential direction so as to create turbine guide blade rows that are arranged between the turbine rotor blade rows. In operation, steam with high thermal energy flows between the turbine rotor blades and the turbine guide blades, and the thermal energy of the steam is converted into rotational energy of the rotor.

Mounting of the individual components, such as the turbine rotor blades in the slot, is carried out at room temperature. By contrast, temperatures of above 600° C. can occur in operation, which leads to increased technical requirements for the construction of such turbo machines.

Turbine components are thus in general subjected to transient thermal loads in operation, which means that thermal changes lead to heating or cooling of the individual turbine components. The thermal capacities and the sizes of the components are generally different, leading to the effect that individual turbine components respond differently to a change in temperature. Less massive turbine components heat up or cool down more quickly than more massive turbine components.

The steels used in the construction of turbo machines have a non-zero coefficient of thermal expansion, and as a result the dimensions of the turbine components change with the changing temperature. In general, the turbine components increase in size as the temperature rises. As a result, during transient temperature changes, stresses can arise between components that are heated at different rates. In particular, stresses can arise between turbine components of different sizes, since these heat up at different rates.

These stresses can lead to substantial mechanical loads for the turbine components, and can even damage the turbine components.

This makes the configuration of turbo machines challenging, in particular during transient operation. Compensating for fluctuating electricity supplies from renewable energy makes it increasingly necessary for steam turbines to be operated in load change operation. In that context, with regard to the economic viability of a power plant, focus is placed on the steam turbine being able to react quickly to a rapid change in load.

The greater the load change gradient and the shorter the start-up time, the greater the thermal loads on the turbine components and thus also the risk of damage to the individual turbine components due to thermal stresses. Also problematic are temperature step changes that must be kept within certain limits.

The rotor and a turbine blade are examples of turbine components. The turbine blades abut tightly against one another in slots that are arranged in the circumferential direction. The turbine blades, around which the incident steam flows during operation, take on temperature changes of the steam very rapidly, which is connected to the fact that turbine blades act as cooling or heating fins, with a large surface area relative to their volume. By contrast, the rotor is exposed to the incident steam during operation only over a relatively small surface area relative to its volume. Thus, the rotor heats up much more slowly than a turbine blade. This means that, for example, a rotor blade row takes up the heat faster and also grows thermally quicker than the rotor, such that the thermal growth of the rotor lags behind the growth of the turbine blades.

This produces thermally induced stresses in the turbine blade anchor points. Since the blade row cannot grow in diameter, compressive stresses in the circumferential direction also arise.

Turbine blades have a blade airfoil and a blade root. Certain embodiments of blade roots have a rhomboidal cross section. In the assembled state, the rhomboidal blade roots bear tightly against one another. In operation, thermal gradients give rise to compressive stresses, with the consequence that rotational forces act at the turbine blade root. As a result, the corners of the rhombus are driven axially into the shaft. The forces can be so great that the corners of the blade root or of the rotor are deformed plastically. As a result, at this point the turbine blade roots no longer bear tightly and become loose.

In order to avoid this problem, the steam turbine is usually operated in such a manner that temperature changes remain within permissible limits.

### SUMMARY OF INVENTION

The invention therefore has an object of specifying a turbine blade that permits more rapid temperature changes during operation.

This object is achieved by a turbine blade as claimed.

The object is also achieved by a method for producing a turbine blade arrangement as claimed.

Advantageous developments are specified in the dependent claims.

The invention thus proposes locally changing the geometry of the blade roots so as to minimize the tendency to plastic deformation in the event of the expected reaction to thermal transients. The effect of the curvature in the side face is that, in the event of increasing twisting of the turbine blade arising during operation, the transmission of forces is reduced, with the result that the resulting stresses are limited and permanent plastic deformation is suppressed. This makes it possible to envisage greater temperature differences or gradients without this leading to blade loosening. This is in particular advantageous during start-up of a steam turbine since it results in no plastic deformation and subsequent blade loosening. This achieves more flexible operation, which translates into shorter start-up times, quicker load changes and the like.

In one advantageous refinement, the curvature is described by a convex curvature. This permits optimal distribution of the transmitted forces.

The curvature is advantageously on the side face starting at the halfway point, since the transmitted forces are more to be expected at the edges of the side faces. Advantageously, the curvature is designed such that, in operation, only elastic deformation takes place. Advantageously, this prevents plastic deformation from taking place.

### BRIEF DESCRIPTION OF THE DRAWINGS

The invention will now be explained in more detail with reference to an exemplary embodiment.

In the drawings:

FIG. 1 shows a perspective view of two turbine blades,

FIG. 2 shows a perspective view of a single turbine blade,

FIG. 3 shows a plan view of multiple turbine blades arranged one behind the other in the installed state,

FIG. 4 shows a representation of the shrouds in the installed state,

FIG. 5 shows a representation of the shrouds in the event of thermal expansion,

FIG. 6 shows a representation of the shrouds in the event of thermal expansion and transmitted forces,

FIG. 7 shows an enlarged representation of a detail from FIG. 6,

FIG. 8 shows an enlarged representation of a turbine blade root.

### DETAILED DESCRIPTION OF INVENTION

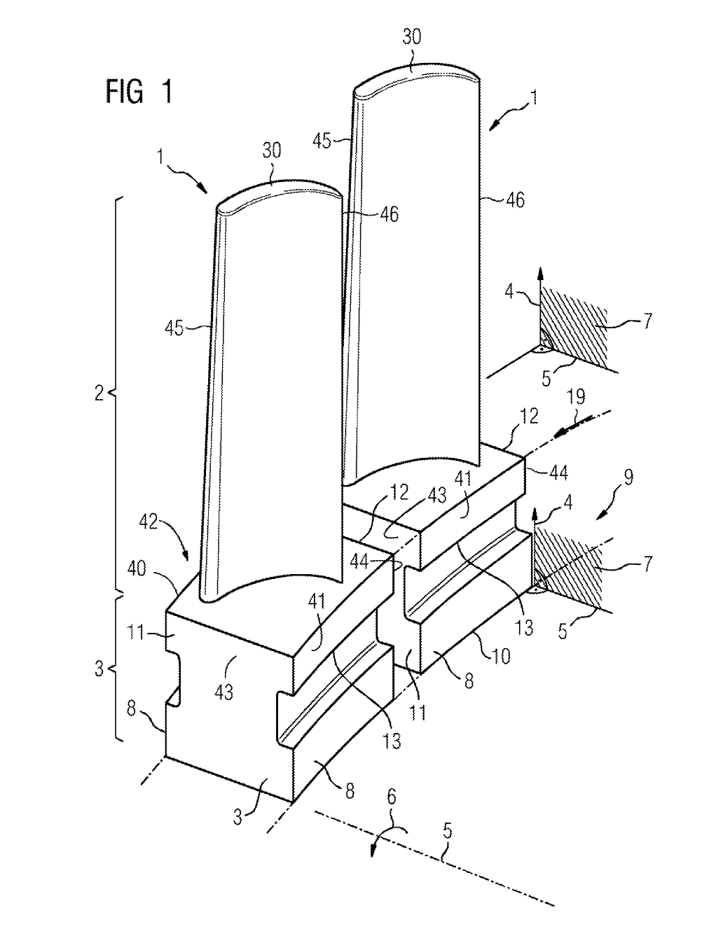

FIG. 1 shows a turbine blade 1. The turbine blade 1 can be a turbine guide blade or a turbine rotor blade. The turbine blade 1 has a blade airfoil 2 and a blade root 3 that are arranged along a blade axis 4. The blade axis 4 essentially corresponds to the longitudinal extent of the turbine blade 1. The blade airfoil 2 is profiled and is intended for installation in a turbomachine, in particular a steam turbine. The turbine blade 1 is inserted into a slot, which is not shown in greater detail. A turbomachine such as a steam turbine has a rotor that is mounted so as to be able to rotate about an axis of rotation 5, and a casing arranged around the rotor. This slot is arranged in a rotor on the surface (not shown), the rotor being created about an axis of rotation 5. Thus, the rotor rotates in a direction of rotation 6 about the axis of rotation 5. In this context, the blade axis 4 is perpendicular to the axis of rotation 5. The axis of rotation 5 and the blade axis 4 form a radius face 7. The blade root 3 has a side face 8 that is essentially perpendicular to the radius face 7 and intersects the axis of rotation 5. FIG. 1 shows a system 9 which shows the orientations of the axis of rotation 5, the blade axis 4 and the side face 8. The blade axis 4 is oriented perpendicular to the axis of rotation 5. The blade axis 4 and the axis of rotation 5 form a radius face 7. The side face 8 is arranged perpendicular to the radius face 7. In the perspective representation of the turbine blade 1, a circumferential direction 10 is partially shown and corresponds essentially to the surface of a rotor, which is not shown in greater detail, and of a slot, which is not shown in greater detail. The blade root 3 has a front face 11 and a rear face 12 which, in the perspective representation of FIG. 1, cannot be shown. A recess 13 is arranged in the side face 8.

In the installed state, the turbine blades 1 are arranged in a circular path about the axis of rotation 5, along a circumferential direction 19. Hence, the circular path is rotationally symmetric with the axis of rotation 5.

The turbine blade 1 has a shroud 14 between the blade root 3 and the blade airfoil 2. The shroud 14 has a parallelogram 42 with a front face 40 and a rear face 41 arranged parallel thereto, and a first abutment face 43 and a second abutment face 44 arranged parallel thereto.

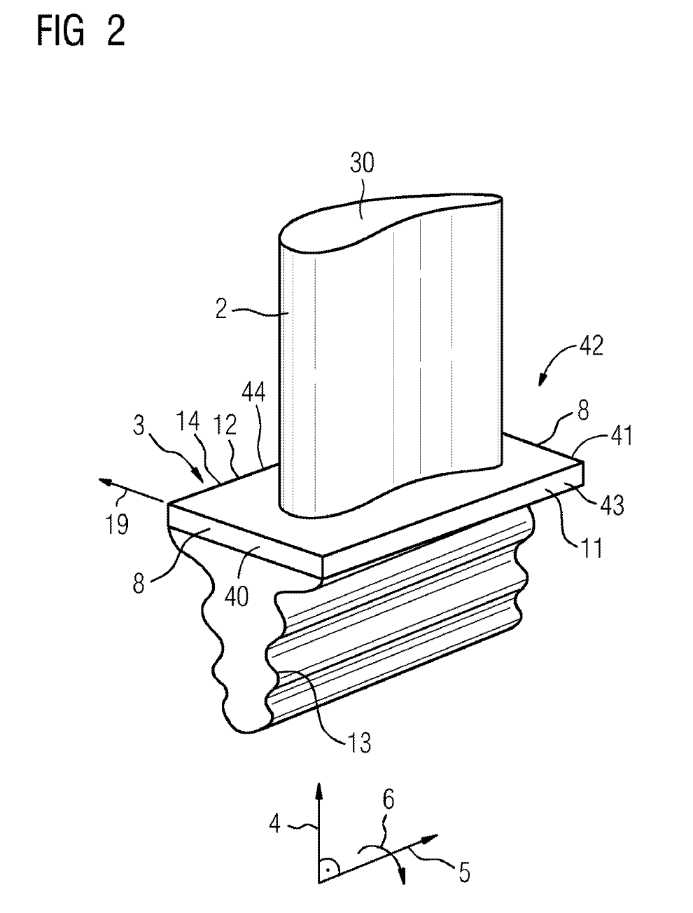

FIG. 2 shows an alternative embodiment of a turbine blade 1. The difference to the turbine blade 1 of FIG. 1 is that the blade root 3 has a fir-tree shape 13 which is arranged in a corresponding complementary fir-tree slot in the rotor.

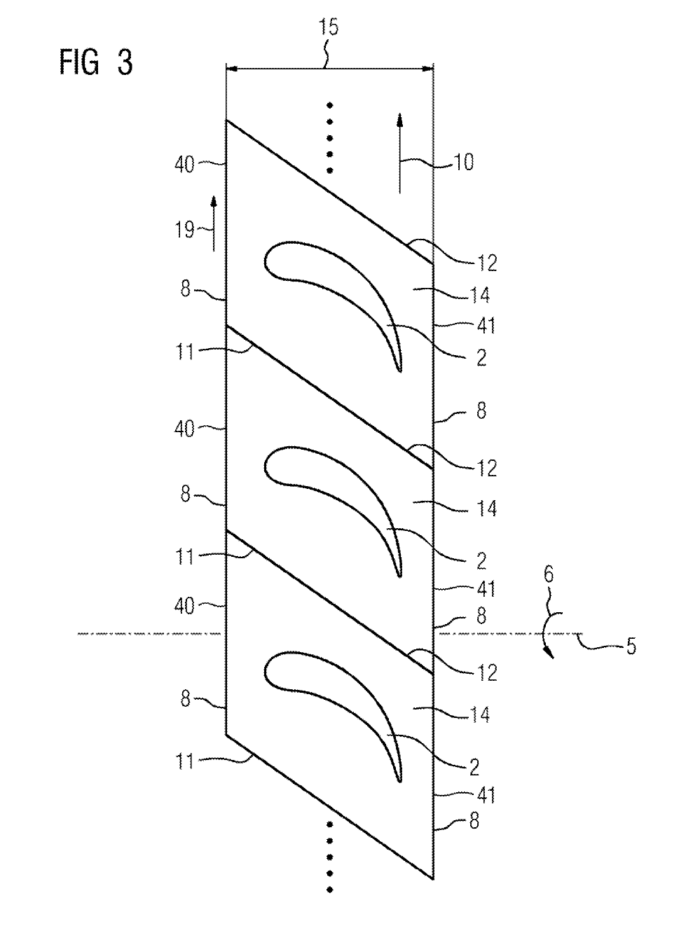

FIG. 3 shows a plan view of a blade arrangement comprising turbine blades 1 bearing tightly behind one another in the circumferential direction 10. The blade root 3 has a shroud 14 which is in the form of a rhombus or a parallelogram. The blade airfoil 2 is arranged on the shroud 14. This means that the front face 11 of the shroud 14 bears against the rear face 12 of the shroud 14. Thus, the front face 11 and the rear face 12 can come into contact. This produces a complete turbine blade row in the circumferential direction 10. For the sake of clarity, only three turbine blades 1 are shown. The blade root 3 has a width 15 as seen in the circumferential direction 10. The rotor (not shown in greater detail) comprises a slot that also has the width 15. Thus, in the installed state, the side faces 8 bear against corresponding slot faces of the slot.

This is shown in FIG. 4, in which only three shrouds 14 of the blade roots 3 are shown. The blade airfoil 2 has not been shown. FIG. 4 represents the installed state at a temperature, for example room temperature. It can be seen that the width 15, which corresponds to the width of the shroud 14 and the width of the slot, is essentially equal.

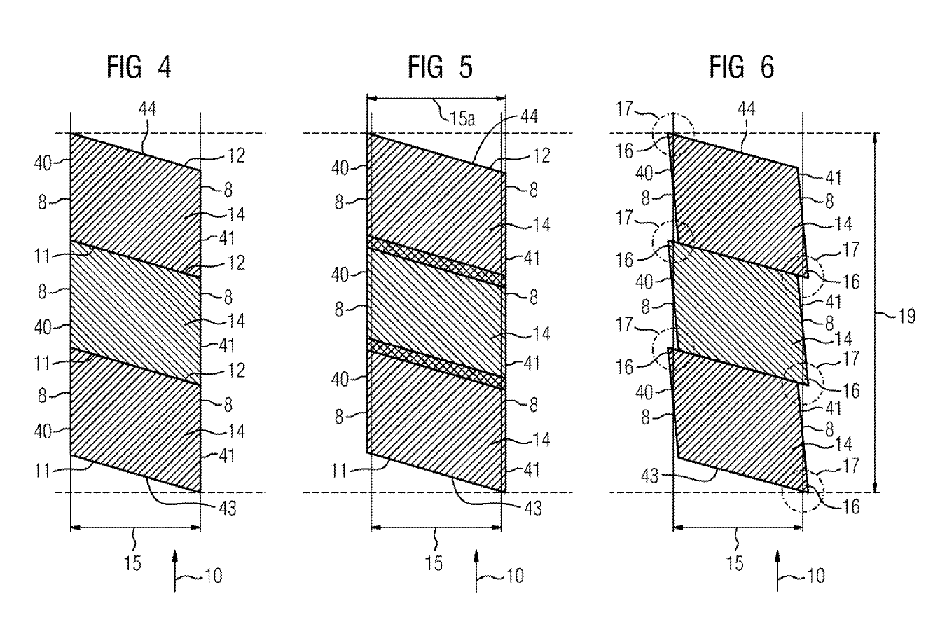

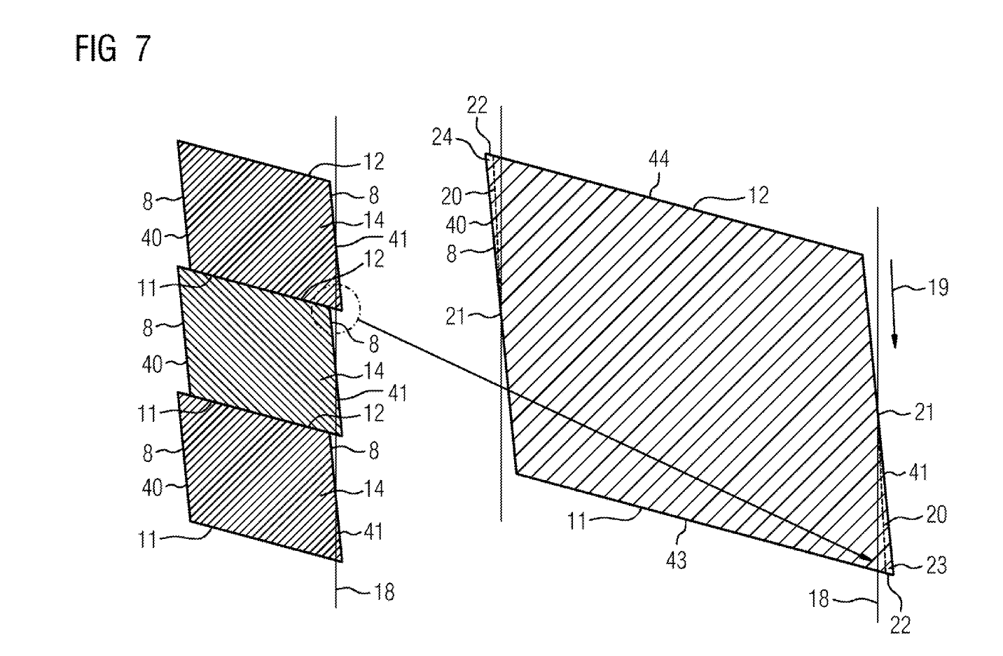

Under certain operating conditions, for example during transient operation, the shroud 14 or the blade root 3 can heat up faster than the slot of the rotor. This theoretical state is shown in FIG. 5, wherein it can be seen that the slot has, as before, the width 15 since in transient operation less thermal expansion has taken place due to the large mass of the rotor. By contrast, the shroud 14 of the blade root 3 has expanded more, due to the low mass, to a width 15a. It is clear that the thermally expanded width 15a is larger than the width 15. It is also clear that the thermal expansion of the shroud 14 in the circumferential direction 10 is such that an overlap is theoretically possible. This leads to states of stress that produce rotation of the shrouds 14, as shown in FIG. 6. FIG. 6 shows the real state in which the shrouds 14, with the blade roots 3, rotate slightly counterclockwise. The result of this is that, at the corners 16, the side face 8 is pressed against the wall of the slot. This state is shown in FIG. 6 in the details highlighted by the circles 17. This state can lead to plastic deformation of the side face 8 at the corners 16 of the shrouds 14.

FIG. 7 again highlights this situation. The line 18 symbolizes the slot wall, the detail illustrated in the circle 17 being shown enlarged on the right-hand side of FIG. 7. The corner 16 of the blade root 3 is formed such that the side face 8 has, in a certain section, a curvature 20 along a circumferential normal 19 to the blade axis 4. This curvature 20 begins approximately at the midpoint 21 of the side face 8 and, in a first embodiment, is straight. The side face 8 is planar in one plane up to the midpoint 21 and exhibits a kink from the midpoint 21, which gives rise to the curvature 20.

The curvature 20 begins at the midpoint 21 and leads up to a side edge 22 that coincides with the front face 11. In that context, the curvature 20 is designed such that, in operation, only elastic deformation of the shroud 14 takes place. In particular, the curvature 20 is such that no plastic deformation results. The curvature 20 runs up to the side edge 22. The side edge 8 and the front side 11 form a corner 23. The angle of the corner 23 is less than 90 degrees (it is therefore acute). Diametrically opposite the corner 23 is the corner 24 formed between the rear side 12 and the side face 8. The corner 24 also has, proceeding from the midpoint 21, a curvature 20 to the side edge 22. The blade root 3 is rhombohedral in the direction of the blade axis 4. The side face 8 is planar with respect to the circumferential normal 19 essentially up to halfway or the midpoint 21.

The turbine blade 1 is designed for installation into a slot, having a slot face, of a rotor of a turbomachine, in particular a steam turbine, wherein, in the installed state, the side faces bear against the side faces of the slot face.

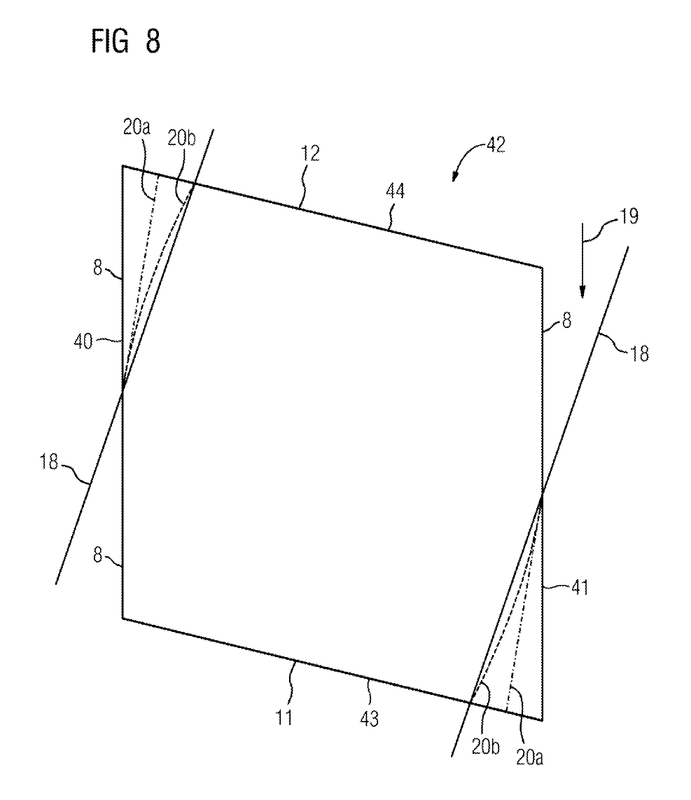

FIG. 8 shows an enlarged representation of the turbine blade root in plan view. It shows, in addition to a first embodiment in which the curvature 20 takes the form of a straight line 20a, a curved convex curvature 20b.

FIGS. 1 to 8 show a turbine blade 1 having a blade airfoil 2 and a blade root 3, wherein the turbine blade 1 is designed for installation in a turbomachine, in particular a steam turbine, wherein the turbomachine has a rotor that is able to rotate about an axis of rotation 5, wherein the blade airfoil 2 has a blade tip 30, wherein the blade root 3 and the blade airfoil 2 are formed along a blade axis 4 that is oriented perpendicular to the axis of rotation 5, wherein the axis of rotation 5 and the blade axis 4 form a radius face 7 and the blade root 3 has a side face 8 that is formed essentially perpendicular to the radius face 7 and intersects the axis of rotation 5, wherein the side face 8 has, in a certain section, a curvature 20 along a circumferential normal 19 to the blade axis 4, wherein, in the installed state, multiple turbine blades 1 are arranged in a circular path about the axis of rotation 5, along a circumferential direction 19.

The figures also show that the curvature 20 is convex.

Furthermore, the side face 8 of the blade root 3 is bounded by side edges 22 and the convex curvature 20b runs to the side edge 22.

Furthermore, the convex curvature 20b is arranged diametrically opposite the side edges 22.

Furthermore, the blade root 3 is rhombohedral as seen in the direction of the blade axis 4.

Furthermore, the side face 8 is planar with respect to the circumferential normal 19 essentially up to halfway, and the curvature 20 is arranged from halfway.

Furthermore, the turbine blade 1 is designed for installation into a slot, having a slot face, of a rotor of a turbomachine, wherein, in the installed state, the side face 8 bears against the slot face, wherein, during operation of the turbomachine, the blade root 3 exerts a force on the slot face via the side face 8, wherein the curvature 20 is designed such that elastic deformation results.

Furthermore, the figures show a method for producing a turbine blade arrangement in a slot of a turbomachine, wherein the turbine blade roots 3 are formed such that, during operation, forces arising between the turbine blade roots 3 and the slot do not lead to the plastic deformation.

1.-10. (canceled)

11. A turbine blade comprising
a blade airfoil and
a blade root, wherein the blade root is designed as a rhomboidal hammerhead root that is arranged in a circumferential slot,
a blade tip that is arranged at one end of the blade airfoil,
a shroud between the blade root and the blade airfoil,
wherein the blade root and the blade airfoil are designed along a blade axis from the blade root to the blade tip,
wherein the shroud has a parallelogram with a front face and a rear face arranged parallel thereto, and a first abutment face and a second abutment face arranged parallel thereto,
wherein the first abutment face is oriented so as to abut against a second abutment face of an adjacent turbine blade,
wherein the blade airfoil is profiled and has a leading edge and a trailing edge, wherein the leading edge points toward the front face and the trailing edge points toward the rear face,
wherein the front face has a curvature in certain sections,
wherein the front face has a length LO and the curvature begins at LKV,
wherein: 0.3 LO<LKV<0.7 LO, 0.2 LO<LKV<0.8 LKV or 0.45 LO<LKV<0.55 LO.

12. The turbine blade as claimed in claim 11,
wherein the rear face has a curvature in certain sections.

13. The turbine blade as claimed in claim 11,
wherein the curvature is about the blade axis.

14. The turbine blade as claimed in claim 11,
wherein the curvature is convex.

15. The turbine blade as claimed in claim 11,
wherein the rear face has a length LO and the curvature begins at LKR,
wherein: 0.2 LO<LKR<0.8 LO, 0.3 LO<LKR<0.7 LO or 0.45 LO<LKR<0.55 LO.

16. The turbine blade as claimed in claim 11,
wherein the curvature is straight.

17. A method for producing a turbine blade arrangement in a slot of a turbomachine, comprising:
forming the turbine blade roots such that forces between the turbine blade roots and the slot, which arise during operation, do not lead to plastic deformation.

18. The method as claimed in claim 17,
wherein the turbine blade roots have a front face bearing against the slot and are formed with a curvature.

19. The method as claimed in claim 17,
wherein the curvature is convex.
